(19) United States
(12) Patent Application Publication
(10) Pub. No.: US 2009/0158258 A1
(43) Pub. Date: Jun. 18, 2009

(54) Instrumentation information gathering system and method

(76) Inventor: Gregory E. James, Redwood City, CA (US)

Correspondence Address: MURABITO HAO & BARNES LLP, Third Floor, Two North Market Street, San Jose, CA, 95113, US

(21) Appl. No.: 12/002,731

(22) Filed: Dec. 17, 2007

(51) Int. Cl. G06F 9/44

(52) U.S. Cl. 717/130

(57) ABSTRACT

Description of a instrumentation information gathering system and method are presented in accordance with embodiments of the present invention. The present invention instrumentation information gathering systems and methods can be utilized to facilitate efficient and flexible instrumentation information gathering. In one embodiment, a static variable associated with instrumentation information is established. Primary code operations are performed and instrumentation information associated with the primary code operations is gathered, wherein the gathering utilizes the static variable.

### FIELD OF THE INVENTION

The present invention relates to instrumentation gathering systems and methods.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, these advantageous results are realized through the use of software instructions for directing processing operations. Instrumentation information associated with the software instructions is often beneficial. However, conventional approaches to gathering the instrumentation information can be complicated and problematic.

Electronic systems designed to produce these results usually involve interfacing with a user and the interfacing often involves presentation of graphical images to the user. Displaying graphics images traditionally involves intensive data processing and coordination requiring considerable resources and often consuming significant power. User experience is usually very important in graphics applications and glitches in image presentation usually have a deleterious effect on user experience. Ensuring proper and efficient processing operations often depends upon effective performance monitoring. Ascertaining and analyzing graphics pipeline performance information is often very difficult and traditional approaches to gathering performance monitoring information are usually limited.

### SUMMARY

Description of instrumentation information gathering systems and methods are presented in accordance with embodiments of the present invention. The present invention instrumentation information gathering systems and methods can be utilized to facilitate efficient and flexible instrumentation information gathering. In one embodiment, a static variable associated with instrumentation information is established. Primary code operations are performed and instrumentation information associated with the primary code operations is gathered, wherein the gathering utilizes the static variable.

### DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is a flow chart of an exemplary instrumentation information gathering method in accordance with one embodiment of the present invention.

FIG. 2 is a block diagram of an exemplary computer system in accordance with one embodiment of the present invention.

FIG. 3 is a flow chart of an exemplary instrumentation analysis method in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

Present invention systems and methods facilitate efficient and effective instrumentation monitoring. In one embodiment, an instrumentation information gathering method utilizes a static variable to generate a small token that is utilized in gathering instrumentation information. In one exemplary implementation, the initialization of the static variable that generates the token is generated once. The token can be utilized multiple times to facilitate instrumentation monitoring without initializing the static variable multiple times.

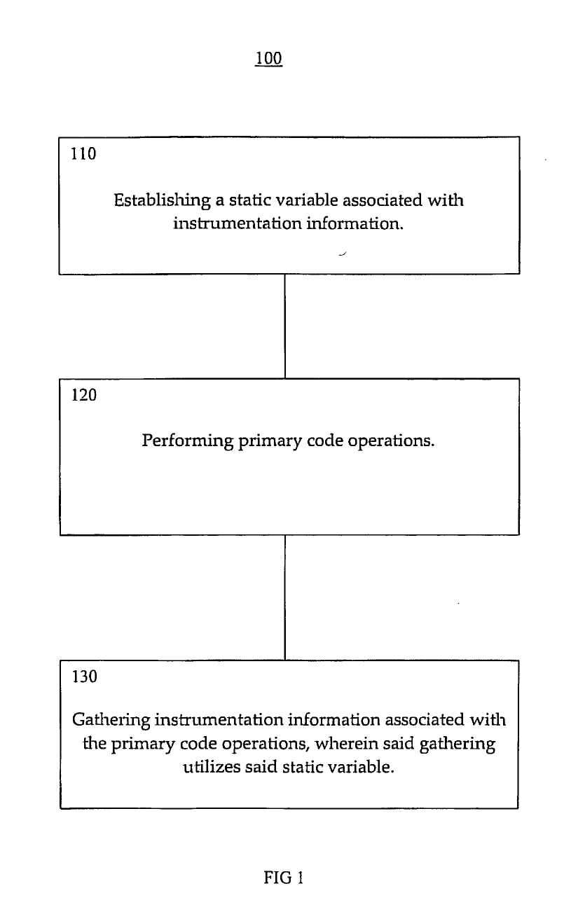

FIG. 1 is a flow chart of exemplary instrumentation information gathering method 100 in accordance with one embodiment of the present invention. In one embodiment, instrumentation information gathering method 100 is utilized to gather instrumentation information associated with primary code characteristics and/or operations.

In step 110, a static variable associated with instrumentation information is established. In one embodiment, the establishing includes declaring the static variable; and initializing the static variable. In one exemplary implementation, the establishment of the static variable includes generation of a token and mapping the token to complicated instrumentation information and functions associated with gathering of the instrumentation information. A collection of tokens can be built up that are mapped to various instrumented sections of the software instructions and contexts are maintained for the tokens.

It is appreciated that the generated tokens can have a variety of configurations and different sizes (e.g., a single byte, multiple bytes, etc.). It is also appreciated that a static variable can also generate a single token or a plurality of tokens. A plurality of static variables can be included at various locations in an application program or portion of a program and can generate a plurality of corresponding tokens.

In one embodiment initialization of the static variable is executed once (e.g., when the variable is first encountered). The value of the static variable persists across multiple invocations of a block of the primary code associated with the static variable. In one exemplary implementation, the value persists across multiple invocations of the code block in which the static variable exists. It is appreciated that a static variable can live a within a function or within a more global space. In one embodiment, the static members can be stored separately from the local function space. This initialization code can be quite complicated, but since it is run only once it has much less impact on the execution of the problem than conventional approaches.

In one embodiment, the token is a location marker value generated during static variable initialization. In one exemplary implementation, the value is generated once regardless of how often it is encountered during program execution. In one exemplary implementation the generated location marker is a small binary value utilized as a location marker in the primary code, wherein the location marker indicates where to bin and store the instrumentation information. By utilizing a static variable assignment to the function for generating the location marker facilitates reduction of processing resource assignment to numerous repetitions of operations associated with the function for generating the location marker. For example, the function for generating the marker location value can be complex and involve a search or long string manipulation, but since the function is only performed once it does not have an overwhelming affect on the primary program operations. This permits a code location to be marked with an in-place string in the code which is usually easier than conventional approaches that define and use unique binary tokens.

In step 120, a primary code operations are performed. It is appreciated a variety of primary code operations can be performed. In one embodiment, the primary code operations are directed to graphics operations. For example, operations associated with drawing an image, rendering, object transformations, clipping, occlusion culling, operations associated with pixel processing, shading, texture mapping, etc.

In step 130, instrumentation information associated with the primary code operations is gathered. In one embodiment, the instrumentation information is gathered and stored in a “bin” or location indicated by the location marker. It is appreciated that a variety of instrumentation information can be gathered. In one exemplary implementation, instrumentation information includes statistical information associated with the primary code operations. The instrumentation information can include performance information associated with the primary code operations. The instrumentation information can also include timing information associated with the primary code operations. The instrumentation data can include how long a portion of the code take to perform operations, the number of time a portion of the code is hit or called, etc.

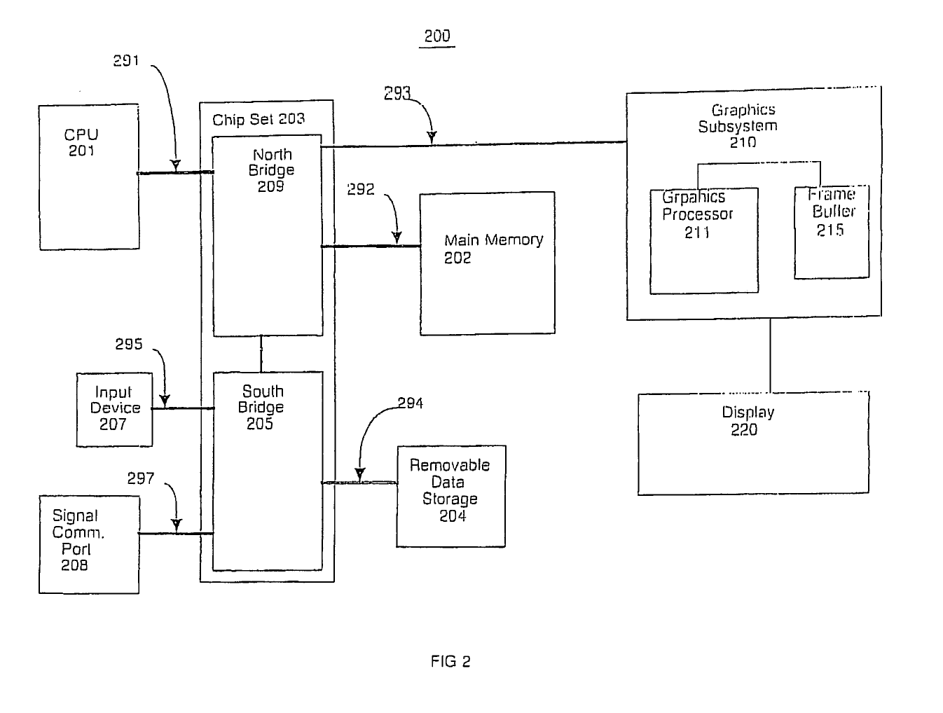

FIG. 2 is a block diagram of an exemplary computer system 200, one embodiment of a computer system upon which embodiments of the present invention can be implemented. Computer system 200 includes central processor unit 201, main memory 202 (e.g., random access memory), chip set 203 with north bridge 209 and south bridge 205, removable data storage device 204, input device 207, signal communications port 208, and graphics subsystem 210 which is coupled to display 220. Computer system 200 includes several busses for communicatively coupling the components of computer system 200. Communication bus 291 (e.g., a front side bus) couples north bridge 209 of chipset 203 to central processor unit 201. Communication bus 292 (e.g., a main memory bus) couples north bridge 209 of chipset 203 to main memory 202. Communication bus 293 (e.g., the Advanced Graphics Port interface) couples north bridge of chipset 203 to graphic subsystem 210. Communication buses 294-297 (e.g., a PCI bus) couple south bridge 205 of chip set 203 to removable data storage device 204, input device 207, and signal communications port 208 respectively. Graphics subsystem 210 includes graphics processor 211 and graphics buffer 215.

The components of computer system 200 cooperatively operate to provide presentations of graphics images. Communications bus 291 through 297 communicate information. Central processor 201 processes information. Main memory 202 stores information and instructions for the central processor 201. Main memory 202 also stores information for directing the gathering of instrumentation information. Removable data storage device 204 also stores information and instructions (e.g., functioning as a large information reservoir). Input device 206 provides a mechanism for inputting information and/or for pointing to or highlighting information on display 220. Signal communication port 208 provides a communication interface to exterior devices (e.g., an interface with a network). Display device 209 displays information in accordance with data stored in frame buffer 215. Graphics processor 211 processes graphics commands from central processor 401 and provides the resulting data to graphics buffer 215 for storage and retrieval by display monitor 220. Graphics process 211 can also be utilized to participate in gathering instrumentation information.

In one embodiment, the processor performs a number of primary functions associated with graphics processing while gathering instrumentation information associated with the graphics operations. In one embodiment, a static variable is utilized in the instrumentation information gathering. For example, the central processing unit gathers the instrumentation information associated with portions of the primary functions performed by the central processing unit and portions of the primary functions performed by a graphics processing unit.

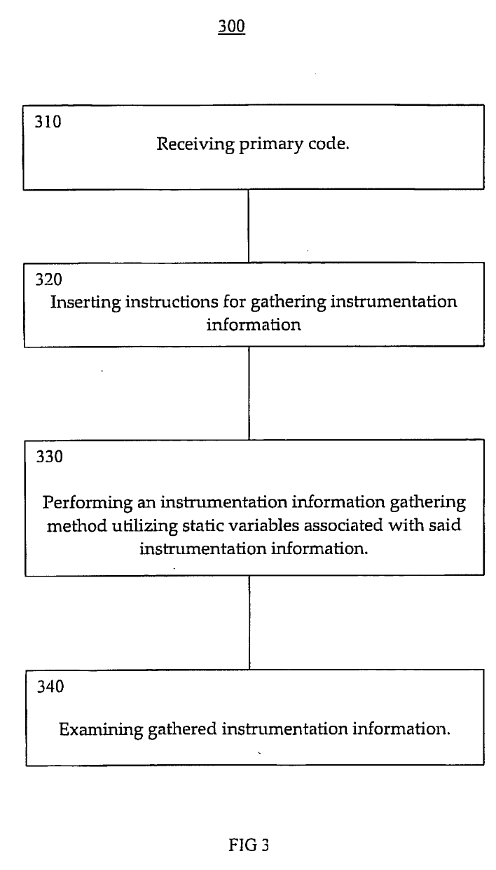

FIG. 3 is a flow chart of an exemplary instrumentation analysis method 300 in accordance with one embodiment of the present invention. It is appreciated instrumentation analysis method 300 can be utilized to gather and analyze instrumentation information associated with a variety of applications including but not necessarily limited to graphics processing applications, communications applications, database applications, etc.

In step 310 primary operation code is received. In one embodiment an example of a portion primary code prior to insertion of instrumentation gathering instructions is expressed by the following pseudo code:

```
HRESULT Function1( int nArg1 )
  {
  ...   ... //instructions for performing a primary function;
  return ( result )
  }
  Void Main Loop( int nTimes)
  {
  ...   ... //instructions for performing a primary function
  For( i=0; I < nTimes; i++ )
    Function1( table[i] );
  }
```

The present example is presented in a pseudo C++ context or abstraction without every possible detail to avoid obscuring the invention in exhaustive syntax and details that may be included in an implementation of actual executable software code. It is appreciated the present invention can be readily implemented with a variety of applications and software instructions. While the present example is presented in a pseudo C++ context, a variety of other abstractions and/or programming languages can be utilized to express the instructions and operations. In addition, numerous instructions and/or operations can be inserted in the “. . . ______ . . . ” portion of the example.

In step 320, instructions for gathering instrumentation information are inserted. In one embodiment, the received primary code is examined and code portions or blocks directing operations related to instrumentations objectives are identified. In one exemplary implementation, instrumentation objectives indicate characteristics, attributes, or things to measure. Static variable with initializers are inserted and instructions associated with functions for performing the instrumentation information are inserted.

In one embodiment, an example of a portion primary code with insertion of instrumentation gathering instructions is expressed by the following code:

```
void Function1( int nArg1 )
{
  static byte Location = GenerateUniqueLocation(”Function1”, int
  Line=14);
  ...   ... // instructions for performing a primary function
  RecordData( Location, GetTime( ), nArg1 );
  return;
}
void MainLoop( int nTimes )
{
...   ... // instructions for performing a primary function
For( i=0; i < nTimes; ++i )
  Function1( i );
}
```

Again, it is appreciated the present invention can be readily implemented with a variety of applications and software instructions. For example, numerous different information gathering functions in addition to or other than GetTime( ) can be included for gathering a variety of different types of instrumentation information (e.g., how many times a primary functions is executed, how much time it takes to execute or perform the primary functions, tracking which portions of primary code call other portions and dependencies between the portions, work load, bandwidth, etc.). In addition, the RecordData function can take any number of arguments and/or be included in multiple locations throughout the body of software. In one exemplary implementation, two RecordData functions may be used to establish the conditions prior to and subsequent to execution of the primary function. In yet another exemplary implementation, any number of variations of the RecordData function can be used within the primary function code or multiple primary functions, where the variations consist of mapping various instrumentation data to the simple token or a plurality of tokens. In yet another exemplary implementation, the declaration and initialization of the static variable token can be expressed in code as a further abstraction, for example as a code macro or preprocessor directive. In one embodiment, this further abstraction could simplify the expression and implementation of the present system and method.

In one embodiment, the GenerateUniqueLocation function generates a small token (e.g., the token named “Location”) based upon more complicated information that a compiler or programmer is providing. Again, the token can consist of any number of bits of information. In one exemplary implementation, the GenerateUniqueLocation function accepts a string which is the name of the function and can also accept another marker to identify the location in the code (e.g., a line number, etc.). The GenerateUniqueLocation function generates a mapping between the data and the simple token that is used upon subsequent entry into the function. When the function is initialized, the function perform a lot of work (e.g., process strings, make lists of things, etc.) and while it can be a lot of work, since it is performed once regardless of the number of times the function is invocated or called, the impact is reduced compared to conventional approaches that performed it multiple times to correspond to multiple invocation or calls to the function. A programmer dose not have to add anything extra to the instructions to limit the execution to once and does not have to check the poll value to make sure it is not done elsewhere.

In step 330 an instrumentation information gathering method is performed. In one embodiment, instrumentation information gathering method 100 is performed. In one exemplary, implementation the information gathering method is utilized to gather instrumentation information associated with graphics processing. For example, gathering graphics processing instrumentation information associated with drawing images, rendering primitives, pixel operations, presentation affects, shading manipulations, applying textures, memory access bandwidth, etc.

It is appreciated a generated token can be static in that it just marks a location or can be dynamic. In one exemplary graphics implementation, a static token is utilized to track rendering of different objects drawn through one location for a draw function, and when recording instrumentation data, a token with the object size indicating how much is drawn and the time it takes to perform the rendering. In another, exemplary implementation, a token can be dynamically incremented for each graphics object that is passed down a graphics pipeline to uniquely gather instrumentation information associated with each successive graphics object.

In step 340 gathered instrumentation information is examined. It is appreciated that a variety of different analysis can be performed on the gathered instrumentation information. In one exemplary implementation, dependencies between various parts of the application are identified using the simple token values (e.g., token “Location” values, other named token values, etc.) and any data recorded in association with them. The gathered instrumentation information can also be utilized in tuning adjustments (e.g., adjustments that improve or alter program execution, adjustments that can improve performance, etc). In one embodiment, these adjustments can improve application or system performance regardless of whether or not the system and method are employed in the final implementation.

It is appreciated that instrumentation information gathered in accordance with the present invention can also be flexibly configuration for convenient communication to and utilization by a variety of automated and enhanced analysis tools.

Thus, the present invention facilitates efficient and effective instrumentation information gathering. In one embodiment, instructions for gathering the instrumentation information have minimal impact on the execution of primary functions. In one exemplary implementation, present invention instrumentation information gathering approaches facilitate reduction of burdens on developers or users.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An instrumentation information gathering method comprising:
establishing a static variable associated with instrumentation information;
performing primary code operations; and
gathering instrumentation information associated with the primary code operations, wherein said gathering utilizes said static variable.

2. An instrumentation information gathering method of claim 1 wherein said establishing said static variable comprises:
declaring said static variable; and
initializing said static variable.

3. An instrumentation information gathering method of claim 2 wherein said initializing is performed once.

4. An instrumentation information gathering method of claim 3 wherein a value of said static variable persists across multiple invocations of a block of said primary code associated with said static variable.

5. An instrumentation information gathering method of claim 1 further comprising generating a small binary value used as a location marker in said primary code, wherein said location marker indicates where to bin and store said instrumentation information.

6. An instrumentation information gathering method of claim 5 wherein said location marker value is generated during said initialization and is generated once regardless of how often it is encountered during said primary code operations.

7. An instrumentation information gathering method of claim 1 wherein said instrumentation information includes statistical information associated with said primary code operations.

8. An instrumentation information gathering method of claim 1 wherein said instrumentation information includes performance information associated with said primary code operations.

9. An instrumentation information gathering method of claim 1 wherein said instrumentation information includes timing information associated with said primary code operations.

10. An instrumentation information gathering method of claim 1 wherein said establishing a static variable associated with instrumentation information comprises:
generation of a token; and
mapping said token to complicated instrumentation information and functions associated with said gathering of said instrumentation information.

11. An instrumentation information analysis system comprising:
a memory for storing instructions for directing performance of primary functions and gathering instrumentation information associated with said primary functions, wherein said instructions for gathering said instrumentation information includes; and
a processor for performing said primary functions and said gathering of said instrumentation information associated with said primary functions, wherein said processor utilizes said static variable associated with said instrumentation information when gathering said instrumentation information.

12. An instrumentation information analysis system of claim 11 wherein said processor is a central processing unit, wherein said central processing unit gathers said instrumentation information associated with portions of said primary functions performed by said central processing unit and portions of said primary functions performed by a graphics processing unit.

13. An instrumentation information analysis system of claim 12 wherein static variables associated with the instrumentation information reside in the central processing unit and tokens associated with said static variable and graphics operations are passed down to said graphics process from said central processing unit.

14. An instrumentation information analysis system of claim 11 wherein said processor gathers instrumentation information from peripherals.

15. An instrumentation analysis method comprising.
receiving primary code;
performing an instrumentation information gathering method utilizing static variables associated with said instrumentation information; and
examining gathered instrumentation information.

16. An instrumentation analysis method of claim 15 further comprising inserting instructions for gathering instrumentation information.

17. An instrumentation analysis method of claim 16 wherein said inserting instructions comprise:
identifying primary code operations to monitor;
inserting static variables associated with instrumentation information related to said monitoring; and
inserting instructions for gathering said instrumentation information.

18. An instrumentation analysis method of claim 17 wherein said inserting static variables comprises:
examining received primary code; and
identifying code portions or blocks directing operations related to instrumentation objectives.

19. An instrumentation analysis method of claim 18 wherein said implementation instrumentation objectives indicate characteristics, attributes, and other things to measure.

20. An instrumentation analysis method of claim 15 wherein said instrumentation information gathering method includes generation of a mapping between data and a simple token, and said mapping is performed once for a static variable and said token is encountered once or more during execution of a program instructions, wherein said program instructions includes said primary code.
